(19) United States
(12) Patent Application Publication
(10) Pub. No.: US 2006/0117621 A1
(43) Pub. Date: Jun. 8, 2006

(54) Loyalty-indicating device and method of use thereof

(76) Inventor: Craig Bartlett, Loganville, GA (US)

Correspondence Address: MYERS & KAPLAN, INTELLECTUAL PROPERTY LAW, L.L.C., 1899 POWERS FERRY ROAD, SUITE 310, ATLANTA, GA, 30339, US

(21) Appl. No.: 10/989,144

(22) Filed: Nov. 15, 2004

(51) Int. Cl. G09F 21/04

(52) U.S. Cl. 40/588

(57) ABSTRACT

A three-dimensional loyalty indicator that can further be utilized as a beverage holder upon inversion of same, wherein a face guard or guards can be extended to permit retention of beverages within the loyalty indicator. The loyalty indicator is window mounted for travel to-and-from a sporting event and can subsequently be inverted to hang from the window and support a plurality of beverage containers therewithin. In an alternate embodiment, a suitably dimensioned double-faced loyalty indicator is provided for use as a surface covering for a vehicle or stationary object.

### TECHNICAL FIELD

The present invention relates generally to sports-related paraphernalia, and more specifically to loyalty-indicating devices and methods of use thereof, wherein the devices serve to show support for a selected sporting team, and wherein the loyalty indicator may be further utilized as a drink holder, and wherein the loyalty indicator could be double-faced to facilitate viewing from either end.

### BACKGROUND OF THE INVENTION

Sporting fans often desire to indicate their loyalty to a particular team. Fans may dress for a sporting event according to the team uniform or team colors, or may even adorn their faces with painted masks to represent their team or its mascot. Other fans prefer to show their loyalty to a broader audience, such as travelers along roads to-and-from the sporting event or visitors to their home, wherein the loyal fans conspicuously place objects indicative of their team support on their vehicle or about their home exterior and/or interior.

For instance, one such method of showing loyalty to a selected team is through adornment of a team pennant, wherein the pennant may have thereon the insignia and/or colors of the selected team, and wherein the pennant may be affixed to a vehicle's antenna or window during travel, particularly travel to-and-from a sporting event involving the team represented by the selected pennant.

When being viewed by other travelers approaching a vehicle from the opposite direction, two-dimensional loyalty indicators will be properly viewed only by an approaching vehicle in close proximity thereto, or by bystanders, wherein viewing from the side provides clear indication of the team and sport that is being supported. However, when such loyalty indicators adorning vehicles are approached from the distant front or rear, it is less evident what team and/or sport is the focus of the fan's loyalty. Further, such loyalty indicators lack any other use and are limited in their aesthetic expression and functionality beyond showing support of the selected team.

For instance, such two dimensional loyalty indicators are of limited different types; therefore, a fan who wants to distinguish his portrayal of loyalty by some noticeable means will find him/herself lacking such expression, since two dimensional loyalty indicators are very commonplace. Structurally, two dimensional loyalty indicators lack the ability to hold or carry any other object, other than the primary purpose of carrying indicia on the surface of the two-dimensional loyalty indicator. Such devices cannot provide a secondary purpose such as securing a beverage container for access by a fan, nor do such two-dimensional devices offer an unique indicator to attract the curiosity of other fans.

Upon arrival at a sporting event, it is customary for fans to partake in “tailgating” before and/or after the sporting event, wherein fans cook foods and/or drink beverages while socializing with other like-minded fans in a vehicular parking lot. Often, because such socializing is carried out within the vicinity of the fans' automobiles, such fans lack a suitable location to securely place their beverages. Although devices for securing beverage containers within a vehicle are often incorporated by the manufacturer of the vehicle, such devices are fixed within the vehicle and, as such, do not provide a person located outside the vehicle with convenient access to a beverage retained therein; thereby inconveniently requiring repeated entry into the vehicle to extract and replace the beverage.

Therefore, it is readily apparent that there is a need for a loyalty indicator that can be viewed from a forward, side and rear position, so as to accurately depict the selected sporting team from any direction. There is a further need for a loyalty indicator that can provide a secure location for placement of beverages therewithin, located on the exterior of a parked vehicle for convenient and expeditious access to same by persons socializing.

### BRIEF SUMMARY OF THE INVENTION

Briefly described, in a preferred embodiment, the present invention overcomes the above-mentioned disadvantages and meets the recognized need for such a device by providing a loyalty-indicating device and method of use thereof, wherein the loyalty-indicating device is three-dimensional and single-faced, or, alternately, double-faced to provide for visual recognition from either direction of vehicular travel, and wherein the device also serves as a secure drink holder for utilization when the vehicle is parked. Further embodiments are directed to double-faced loyalty-indicating devices configured or dimensioned to operate as a surface covering for a vehicular or stationary object.

According to its major aspects and broadly stated, the present invention in its preferred form is a loyalty indicator to show support of a selected team and/or sport, wherein the loyalty indicator is adapted to receive beverage containers and has a form suitable for viewing from a single direction, or alternately, could be double-faced to provide a similar visual appearance from both front and rear viewing positions.

More specifically, the present invention is a loyalty indicator in helmet form, attached to a riser, wherein the riser has a window attachment member. The helmet has indicia thereon to show loyalty to a selected sporting team. The helmet further comprises a face guard, preferably in the form most common to football helmets. The loyalty indicator can be utilized in upright position while travelling to a sporting event, and upon arrival at the event, the loyalty indicator can be inverted for use as a beverage container holder.

The beverage container is supported by a ledge on the helmet portion of the loyalty indicator and is securely retained within the helmet by slidably moving the face guard in or out to position the face guard proximate the beverage container.

The loyalty indicator attaches to the window of a vehicle via a window clamp at the end of the riser. The window clamp has opposing lips that engage a window, each lip being selected according to whether the loyalty indicator is in upright or inverted position. The window clamp is wider at the base (referenced to the inverted mode) to provide additional support in those instances when the loyalty indicator is carrying a beverage container.

Alternate embodiments include a double-faced loyalty indicator that can support a plurality of beverages, a loyalty indicator with a trash bag hook, and a loyalty indicator in the form of a vehicle or vehicular covering. The double-faced loyalty indicator effectively provides a frontal view when viewed from either a forward or rear position.

Accordingly, a feature and advantage of the present invention is its ability to signify loyalty to a particular sporting team.

Another feature and advantage of the present invention is its ability to provide visual recognition of a sporting team from two different directions.

Still another feature and advantage of the present invention is its ability to provide a secure location for placement of beverages.

Yet another feature and advantage of the present invention is its ability to show loyalty to a selected team during travel and to be subsequently utilized as a beverage holder.

Yet still another feature and advantage of the present invention is its ability to contain drinking utensils.

A further feature and advantage of the present invention is its ability to support a trash bag.

These and other features and advantages of the present invention will become more apparent to one skilled in the art from the following description and claims when read in light of the accompanying drawings.

### BRIEF DESCRIPTION OF THE DRAWINGS

The present invention will be better understood by reading the Detailed Description of the Preferred and Selected Alternate Embodiments with reference to the accompanying drawing figures, in which like reference numerals denote similar structure and refer to like elements throughout, and in which:

FIG. 1 is a front view of a loyalty-indicating according to a preferred embodiment of the present invention, shown in use as a loyalty indicator;

FIG. 2 is a side view of a loyalty-indicating device according to a preferred embodiment of the present invention, shown inverted for use as a beverage container holder;

FIG. 3 is a top view of the inverted loyalty-indicating device of FIG. 2 according to a preferred embodiment of the present invention;

FIG. 4 is a side view of a loyalty-indicating device according to an alternate embodiment of the present invention, shown in use holding multiple beverage containers;

FIG. 5 is a top view of the loyalty-indicating device of FIG. 4 according to an alternate embodiment of the present invention, shown in use holding beverage containers and drinking utensils;

FIG. 6 is a front view of a loyalty-indicating device according to an alternate embodiment of the present invention; and

FIG. 7 is a side view of a loyalty-indicating device according to an alternate embodiment of the present invention.

### DETAILED DESCRIPTION OF THE PREFERRED AND SELECTED ALTERNATE EMBODIMENTS

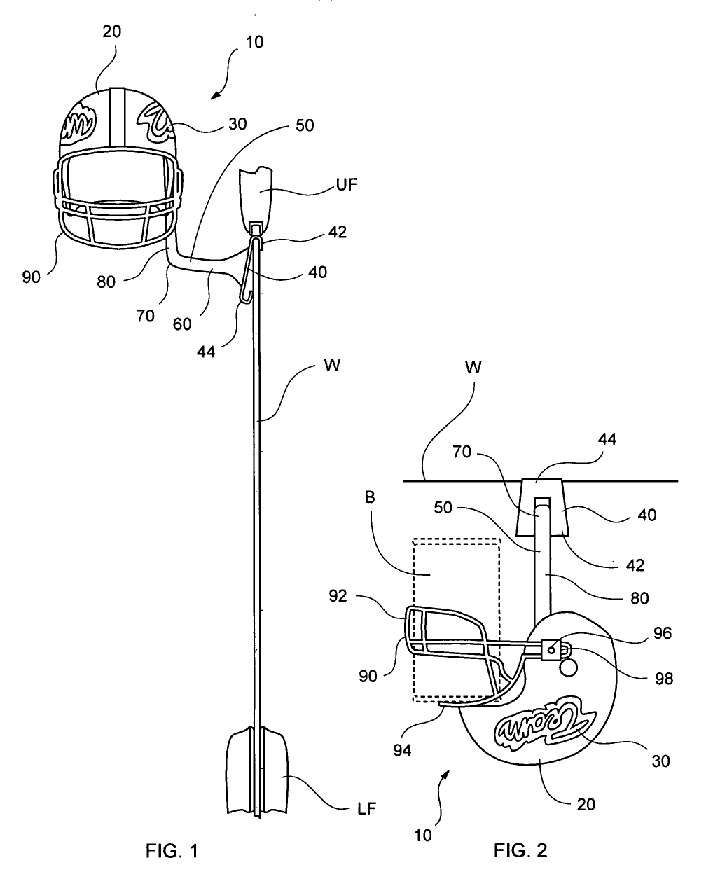

In describing the preferred and selected alternate embodiments of the present invention, as illustrated in FIGS. 1-7, specific terminology is employed for the sake of clarity. The invention, however, is not intended to be limited to the specific terminology so selected, and it is to be understood that each specific element includes all technical equivalents that operate in a similar manner to accomplish similar functions.

Referring now to FIGS. 1-3, the present invention in a preferred embodiment is three-dimensional loyalty indicator 10, wherein loyalty indicator 10 preferably comprises helmet 20, riser 50, and window clamp 40. Helmet 20 preferably comprises face guard 90 and preferably carries selected indicia 30, wherein selected indicia 30 preferably depicts the name, logo or mascot of the selected sporting team for which loyalty is desired to be shown. It will be recognized by those in the art that, in addition to helmet 20, loyalty indicator 10 could comprise any similar equipment relating to other sports, such as, for exemplary purposes only, a batting helmet for baseball.

Riser 50 preferably comprises first arm 60, angled portion 70 and second arm 80, wherein first arm 60 is preferably fixably attached to window clamp 40, and wherein helmet 20 is preferably fixably attached to second arm 80, and wherein second arm 80 preferably extends upward relative to a ground surface. It is envisioned in alternate embodiments of the present invention that first arm 60 could be fixably secured to window clamp 40 by adhesive, fastener, or the like, and/or that first arm 60, angled portion 70, second arm 80 and window clamp 40 could alternately be molded, or integrally formed, as a single piece.

Window clamp 40 preferably comprises first retaining lip 42 and second retaining lip 44, wherein either first retaining lip 42 or second retaining lip 44 is preferably selected for placement over vehicle window W. Accordingly, loyalty indicator 10 is preferably utilized in an upright position by placement of first retaining lip over vehicle window W, wherein vehicle window W is subsequently raised to secure window clamp 40 between vehicle window W and upper window frame UF. In such a secured fashion, loyalty indicator 10 is preferably utilized to demonstrate loyalty to a sporting team while a vehicle is in motion. While a vehicle is stationary, loyalty indicator 10 may be utilized to support beverage B therewithin, wherein loyalty indicator 10 is preferably placed in an inverted position, as more fully described hereinbelow. It will be recognized by those skilled in the art that loyalty indicator 10 could be located either inside or outside window W.

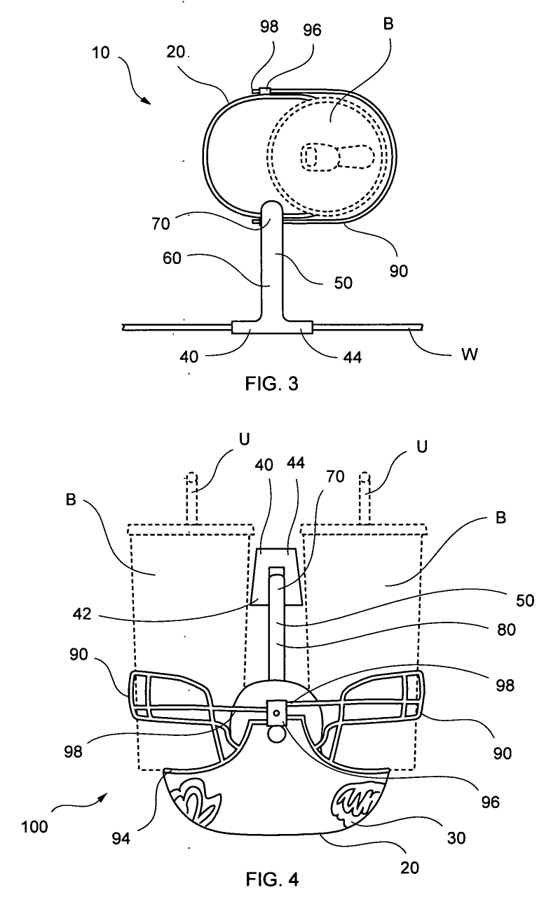

Referring now more specifically to FIGS. 2 and 3, loyalty indicator 10 is shown in an inverted position for support of a selected beverage container B therewithin, wherein second arm 80 preferably extends downward away from window W a distance equal to first arm 60, and wherein second retaining lip 44 of window clamp 40 is preferably secured upon window W, subsequent to window W being lowered into lower frame LF. Second retaining lip 44 is preferably wider than first retaining lip 42 to provide additional support strength for loyalty indicator 10 when beverage container B is placed within inverted loyalty indicator 10. It will be recognized by those skilled in the art that various beverage containers, such as, for exemplary purposes only, cans, cups, bottles, or the like, could be selectively utilized, wherein beverage containers B are removably secured within loyalty indicator 10.

As such, inverted loyalty indicator 10 preferably comprises helmet 20 carrying selected indicia 30, and face guard 90, wherein face guard 90 preferably comprises grill 92, ledge 94 and extension 98, and wherein extension 98 preferably slidably engages helmet 20 via retainer 96. Beverage container B is preferably removably secured within face guard 90, wherein beverage container B is preferably retained by grill 92 and supported by ledge 94. Face guard 90 is preferably slidably secured proximate to beverage container B, by sliding extension 98 within retainer 96, wherein extension 98 is frictionally grasped by retainer 96.

Accordingly, when in an upright position, loyalty indicator 10 can be utilized to demonstrate loyalty to a selected sporting team while travelling to a sporting event. Upon reaching the event location, beverage container B can be readily placed within an inverted loyalty indicator 10 during tailgating parties, and subsequently during return travel, reverted to an upright position to demonstrate loyalty to the selected sporting team.

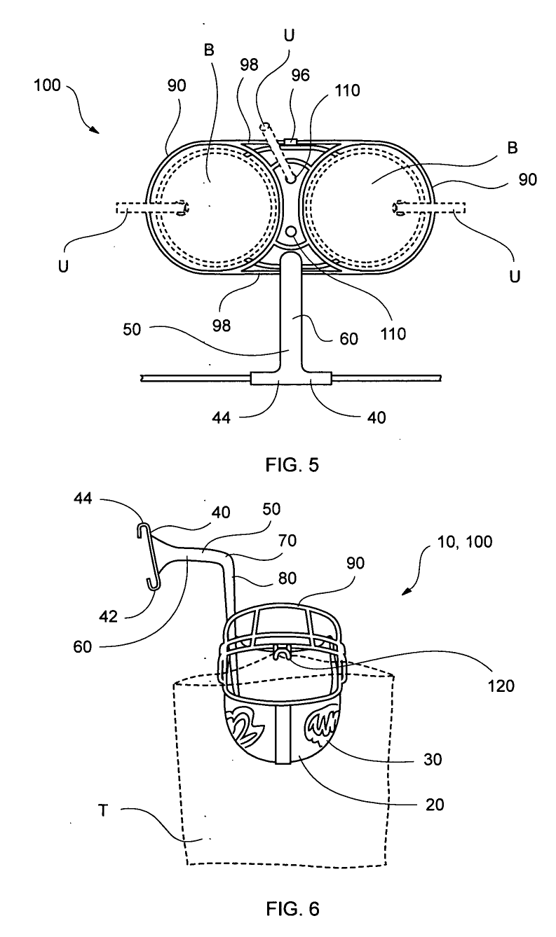

Referring now more specifically to FIGS. 4-5, illustrated therein is an alternate embodiment of device 10, wherein the alternate embodiment of FIGS. 4-5 is substantially equivalent in form and function to that of the preferred embodiment detailed and illustrated in FIGS. 1-3 except as hereinafter specifically referenced. Specifically, the embodiment of FIGS. 4-5 comprises double-faced loyalty indicator 100, wherein double-faced loyalty indicator 100 comprises helmet 20, indicia 30, face guards 90, window clamp 40 and riser 50. Window clamp 40 comprises first arm 60, angled portion 70, second arm 80, first retaining lip 42 and second retaining lip 44.

Double-faced loyalty indicator 100 can be utilized in an upright position, or an inverted position as shown in FIGS. 4-5. While inverted, double-faced loyalty indicator 100 can retain beverage containers B within face guards 90, wherein face guards 90 can be slidably extended or contracted via extensions 98, and wherein extensions 98 are frictionally grasped by retainer 96. While being retained by face guards 90, beverage containers B are further supported by ledges 94.

In addition to containing beverage containers B, double-faced loyalty indicator 100 further comprises apertures 110 for securing drinking utensils U, such as, for exemplary purposes only, drinking straws.

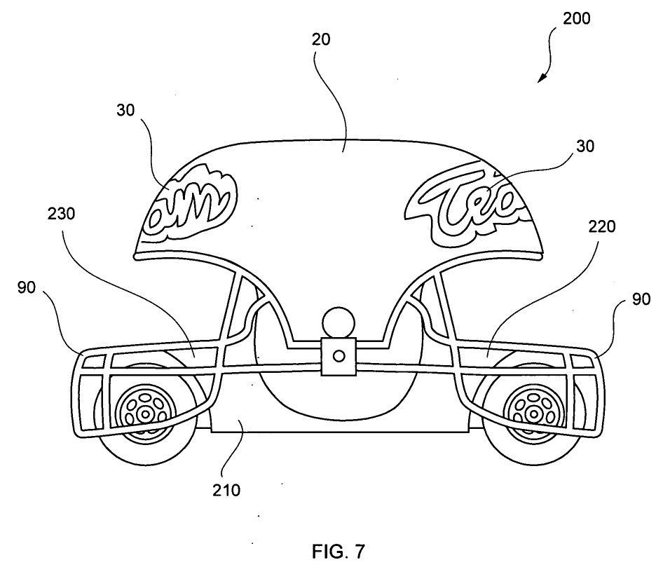

Referring now more specifically to FIG. 6, illustrated therein is an alternate embodiment of device 10, wherein the alternate embodiment of FIG. 6 is substantially equivalent in form and function to that of the preferred embodiment detailed and illustrated in FIGS. 1-3 except as hereinafter specifically referenced. Specifically, the embodiment of FIG. 6 comprises loyalty indicator 10 or loyalty indicator 100 in an inverted position, wherein loyalty indicator 10 or 100 further comprises hook 120, wherein hook 120 is suited for installation of trash bag T thereupon. Accordingly, loyalty indicator 10 or 100 can facilitate keeping the surrounding area clear of refuse.

Referring now more specifically to FIG. 7, illustrated therein is an alternate embodiment of device 10, wherein the alternate embodiment of FIG. 7 is substantially equivalent in form and function to that of the preferred embodiment detailed and illustrated in FIGS. 1-3 except as hereinafter specifically referenced. Specifically, the embodiment of FIG. 7 comprises double-faced loyalty indicator 200, wherein double-faced loyalty indicator comprises vehicle 210 and helmet 20, and wherein helmet 20 comprises indicia 30 and face guards 90. Face guards 90 are disposed at first end 220 and second end 230 of vehicle 210, whereby when vehicle 210 is approached from first end 220 or second end 230, loyalty indicator 200 appears as a front view of helmet 20. In another alternate embodiment, loyalty indicator 200 could comprise a stationary object, such as, for exemplary purposes only, a lawn ornament.

It is envisioned in an alternate embodiment of the present invention that loyalty indicator 200 could comprise an aerial loyalty indicator.

It is envisioned in an alternate embodiment of the present invention that loyalty indicator 10 or 100 could mount to a vehicle antenna or mirror. In such an alternate embodiment, loyalty indicator 10 or 100 would not require riser 50, wherein an alternate fastening means other than window clamp 40 could be selectively utilized.

Advertisers often find it desirable to place their messages upon vehicles, wherein a vehicle is often adorned with the appropriate art and/or message. Accordingly, in an alternate embodiment of the present invention, indicia 30 of loyalty indicator 200 could comprise such an advertising message.

It is anticipated in a further alternate embodiment of the present invention that loyalty indicators 10, 100 and/or 200 could include opposing/rival teams on either side/face of helmet 20.

The foregoing description and drawings comprise illustrative embodiments of the present invention. Having thus described exemplary embodiments of the present invention, it should be noted by those skilled in the art that the within disclosures are exemplary only, and that various other alternatives, adaptations, and modifications may be made within the scope of the present invention. Many modifications and other embodiments of the invention will come to mind to one skilled in the art to which this invention pertains having the benefit of the teachings presented in the foregoing descriptions and the associated drawings. Although specific terms may be employed herein, they are used in a generic and descriptive sense only and not for purposes of limitation. Accordingly, the present invention is not limited to the specific embodiments illustrated herein, but is limited only by the following claims.

What is claimed is:

1. A three-dimensional loyalty indicator comprising:
at least two faces.

2. The loyalty indicator of claim 1, wherein said loyalty indicator comprises a device selected from the group consisting of vehicular-borne loyalty indicators, stationary loyalty indicators and aerial loyalty indicators.

3. The loyalty indicator of claim 2, wherein said vehicular-borne loyalty indicators comprise devices selected from the group consisting of vehicle coverings, antenna-mounted loyalty indicators, mirror-mounted loyalty indicators, window-mounted loyalty indicators, and combinations thereof.

4. The loyalty indicator of claim 3, wherein said window-mounted loyalty indicators comprise a means for attaching to a window, a support, and a loyalty signifier carried by said support.

5. The loyalty indicator of claim 1, further comprising means for signifying loyalty to a sporting team.

6. The loyalty indicator of claim 1, wherein said loyalty indicator comprises at least one extendible member.

7. The loyalty indicator of claim 6, further comprising a helmet, wherein said at least one extendible member comprises at least one extendible face guard carried by said helmet.

8. The loyalty indicator of claim 1, wherein said loyalty indicator is adapted to receive at least one beverage container therein.

9. The loyalty indicator of claim 8, wherein said loyalty indicator is adapted to receive at least one drinking utensil therein.

10. The loyalty indicator of claim 9, wherein said at least one drinking utensil comprises at least one straw.

11. The loyalty indicator of claim 1, comprising first upright position and second downward position, wherein said loyalty indicator is reversible from said first upright position to said second downward position and vice versa.

12. The loyalty indicator of claim 1, further comprising means for supporting at least one article therefrom.

13. A method of demonstrating loyalty, said method comprising the steps of:
a. obtaining a three-dimensional loyalty indicator having at least one face; and
b. displaying said loyalty indicator.

14. The method of claim 13, wherein said loyalty indicator comprises means for holding at least one beverage container.

15. The method of claim 13, wherein said loyalty indicator is reversible from upright display position to downward beverage-holding position.

16. The method of claim 13, wherein said loyalty indicator further comprises means for supporting at least one article therefrom.

17. The method of claim 13, further comprising the step of:
attaching said loyalty indicator to a vehicle.

18. A three-dimensional loyalty-indicating drink holder comprising:
means for indicating loyalty to a sporting team; and
means for holding at least one beverage.

19. The loyalty-indicating drink holder of claim 18, further comprising means for securing to a vehicle.

20. The loyalty-indicating drink holder of claim 18, wherein said means for indicating loyalty comprises a helmet.

21. A three-dimensional loyalty indicator comprising:
a single face; and
a window mount.

22. The three-dimensional loyalty indicator of claim 21, adapted to be utilized as a beverage holder.

23. A three-dimensional loyalty indicator comprising:
two faces, and
a window mount.

24. The three-dimensional loyalty indicator of claim 23, adapted to be utilized as a beverage holder.

25. The three-dimensional loyalty indicator of claim 23, further comprising indicia of rival/opposing teams.

26. The three-dimensional loyalty indicator of claim 23, wherein said loyalty indicator is dimensioned for covering objects selected from the group consisting of vehicles and stationary objects.

27. A multi-functional loyalty indicator comprising: mounting means;
loyalty indicia; and
means for supporting a beverage container.
